(19) United States
(12) Patent Application Publication
(10) Pub. No.: US 2014/0159403 A1
(43) Pub. Date: Jun. 12, 2014

(54) GRIP STRUCTURE OF PORTABLE TERMINAL

(71) Applicant: Yong Sun Kim, Gunsan-si (KR)

(72) Inventor: Yong Sun Kim, Gunsan-si (KR)

(21) Appl. No.: 14/233,884

(22) PCT Filed: Jul. 24, 2012
(86) PCT No.: PCT/KR2012/005885

§ 371 Date: Jan. 21, 2014

(30) Foreign Application Priority Data
Jul. 29, 2011 (KR) 20-2011-0006921
Sep. 6, 2011 (KR) 10-2011-0090325

(51) Int. Cl. F16M 13/04

(52) U.S. Cl. CPC F16M 13/04
USPC 294/137

(57) ABSTRACT

Disclosed is a grip structure of a portable terminal, which comprises a fixed section fixed on an edge of the rear surface of the tablet PC; a perforated section on the center thereof; and a body insertion section formed between the fixed section, and the body insertion section that is concavely curved towards the perforating unit such that fingers and the like can be easily inserted, and the perforated unit is formed in the shape of a circle.

### TECHNICAL FIELD

The present invention relates to a grip structure of a portable terminal, more specifically to a plate-shaped grip structure provided on a rear side of a portable terminal such as a tablet PC.

### BACKGROUND ART

So-called tablet PCs such as the iPhone, which have been garnering much attention recently, are becoming lighter in weight and easier to carry according to performance developments of batteries, memories and the like, and thus are gradually being released as portable terminals with wider screens.

However, since a width of a device is necessarily widened according to the wider screen of the portable terminal, it is difficult for users with small hands to hold such devices in one hand and manipulate them.

The present inventor have developed and applied a strip-attached (belt type) handle structure (Korean Patent Application No. 10-2011-0056477, 2011.5.6, Yong Sun Kim) which is applicable to smartphones such as the iPhone, so that users can easily manipulate the device with only one hand without altering the appearance of the device, such as the thickness.

However, the strip-attached handle structure is not efficient for gripping a tablet PC, which is larger than a smartphone. This is because, although tablet PCs are larger and heavier than smartphones and thus several fingers or a hand itself should be used to grip the device in various methods, the one-way strip-attached handle structure has a small area in contact with the body and gripping methods therefor are limited.

Accordingly, to solve these problems, the present inventors have invented a plate-shaped grip structure of a uniform shape that can be mounted on a rear side of a tablet PC to be used as a more convenient method.

### DISCLOSURE

### Technical Problem

The present invention is directed to providing a grip mounted on a rear side of a portable terminal, especially a tablet PC and the like.

The present invention is further directed to providing a grip for a portable terminal, a grip structure of which is a comfortable and convenient structure for users.

The present invention is further directed to providing a grip which provides a protection function of a device in addition to a grip function.

### TECHNICAL SOLUTION

One aspect of the present invention provides a grip structure formed on a rear surface of a portable terminal, wherein the grip structure includes fixed sections (5) formed on corners of the rear surface, a perforated section (1) disposed at a center thereof, and body insertion sections (3) formed between the fixed sections (5).

The body insertion sections (3) may be concavely curved toward the perforated section such that fingers and the like can be easily inserted.

The perforated section (1) may be formed in a circular shape, and the grip may be made of leather or a fabric.

### ADVANTAGEOUS EFFECTS

A grip according to the present invention has a solid grip as shown in FIGS. 3 to 9. Furthermore, the grip can be gripped in any direction and the direction thereof can be freely changed.

In particular, by using natural leather or a fabric having a good feel for the grip, satisfaction in use can be increased, and it can also serve as a shock absorber to protect the device when the device falls.

### DESCRIPTION OF DRAWING

FIG. 1 illustrates a perspective view of a device on which a terminal grip is mounted according to an embodiment of the present invention.

FIG. 2 illustrates an exploded perspective view of FIG. 1.

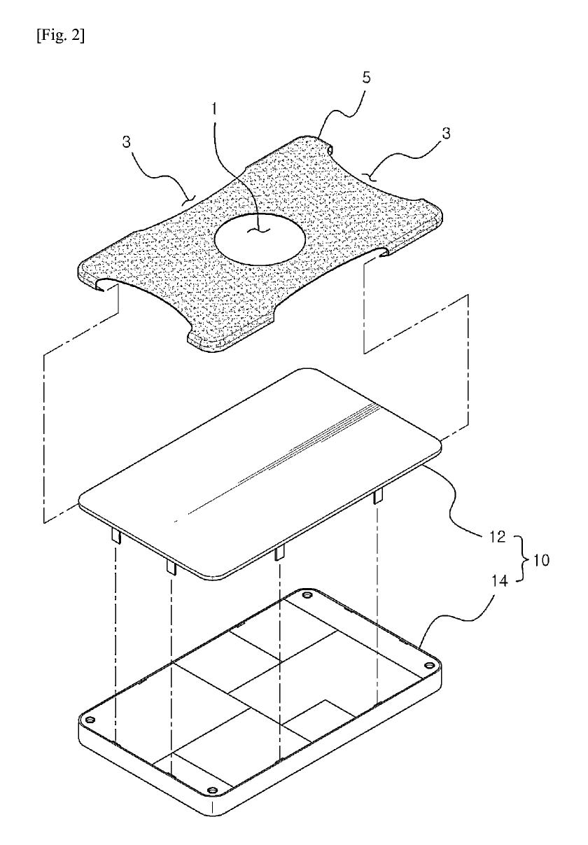

FIG. 3 illustrates a perspective view showing the inside of a terminal cover.

FIG. 4 illustrates a state diagram showing the use of a grip using a longitudinal palette type.

FIG. 5 illustrates a state diagram showing the use of a grip using longitudinal center insertion.

FIG. 6 illustrates a side view of FIG. 5.

FIG. 7 illustrates a state diagram showing the use of a longitudinal side grip.

FIG. 8 illustrates a side view of FIG. 7.

FIG. 9 illustrates a state diagram showing the use of a transverse side grip.

FIG. 10 illustrates a state diagram showing the use of a grip using transverse center insertion.

### MODES OF THE INVENTION

The ideas of the present invention will now be described with reference to the accompanying drawings in order to be understood clearly and easily. The term ‘portable terminal’ used in the present invention refers generically to a so-called mobile phone, smartphone, tablet PC, PDA, PMP, e-Book reader or the like.

As used herein, the term ‘rear surface’ refers to the cover of the rear portion of the main unit case or the surface of a protective cover mounted on the rear portion of the body of the terminal (hereinafter also referred to as a ‘device’).

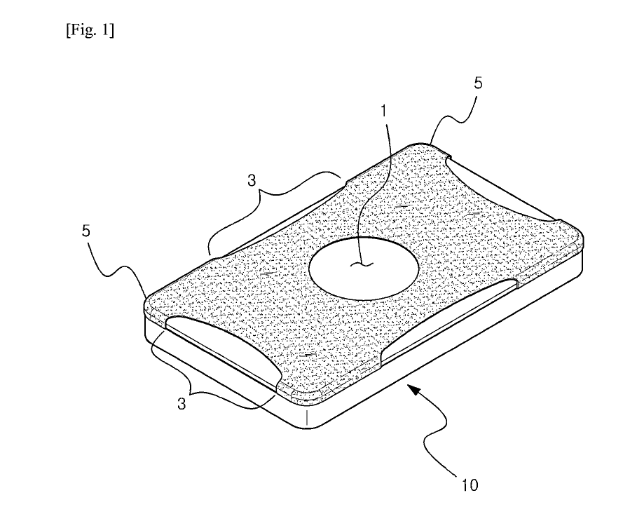

FIG. 1 is a perspective view showing an embodiment of a plate-shaped grip formed on a rear surface of a tablet PC according to an exemplary embodiment of the present invention. The plate-shaped grip is formed on a rear surface 12 of a body 10 of the tablet PC according to an exemplary embodiment of the present invention, wherein fixed sections 5 fixed at four corners of the rear surface 12 of the body 10 have shapes (i.e., [symbol] or [symbol] shapes) that surround the corners, a perforated section 1 is formed at a center in a circular shape, and body (finger) insertion sections 3 formed on sides between the fixed sections 5 are concavely curved toward the perforated section to allow smooth insertion of fingers.

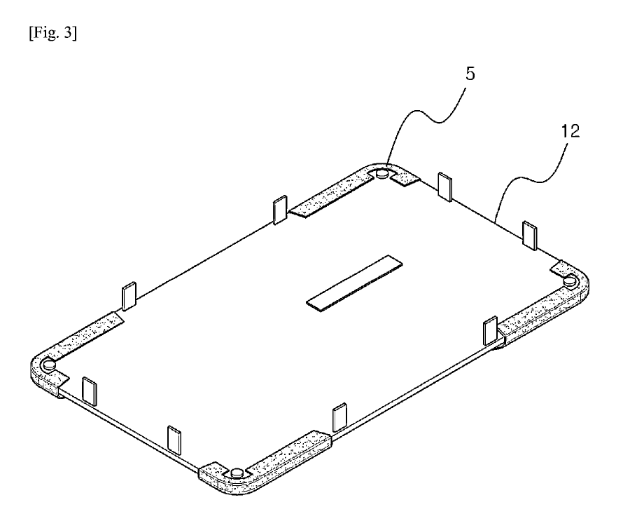

The grip of the present invention formed as described above is mounted on the rear surface of a device body of the tablet PC and the like, or the rear surface of a protective cover. In an application method of the present invention, the fixed sections 5 may be adhered to the corners of the rear cover 12 of the device body, or structurally combined with a joint part in which the rear cover is combined with a body 14. Embodiments of the present invention show methods in which the fixed sections 5 are adhered to the rear cover 12 as shown in FIG. 3 and structurally combined with the body 14 as shown in FIG. 1.

However, a fixing method is not limited to those described above, but various structures and methods may be used, and since a person skilled in the art can easily select these according to characteristics or requirements of the devices, detailed description thereof will be omitted for the sake of brevity.

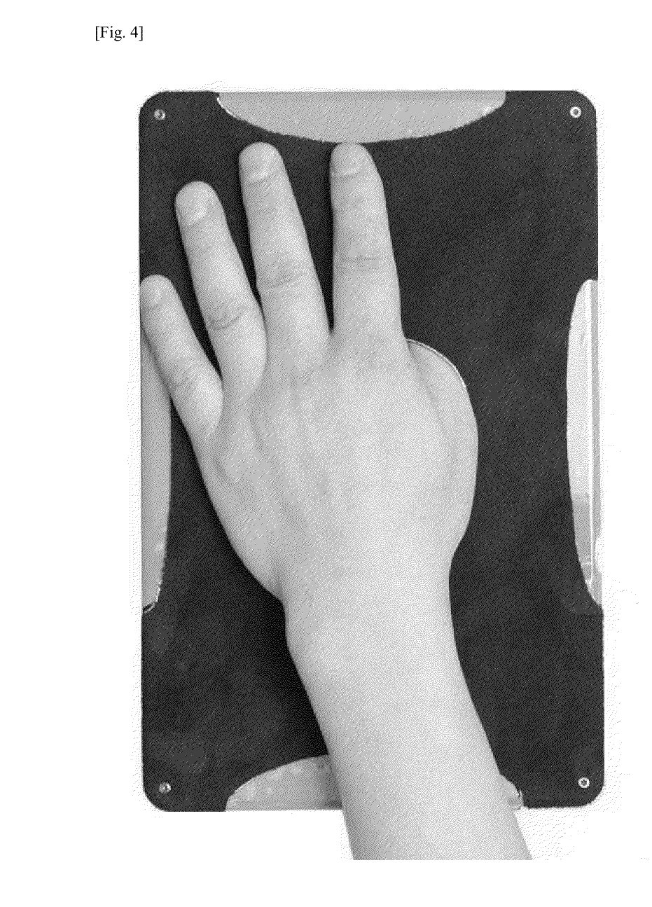

In the present invention, as shown in FIGS. 4 to 10, as the fixed sections 5 at four positions and the body insertion sections 3 formed between the fixed sections are arranged with preferable sizes, sections other than the fixed sections, that is, the side body insertion sections 3 and the perforated section 1 formed at a center thereof, are spaced apart from the rear surface of the body at short intervals so that a hand or fingers may be inserted.

Accordingly, since the grip of the present invention is preferably made of a material having suitable elasticity, natural leather, imitation leather, a synthetic resin fabric or the like may be used. Since the grip of the present invention is used by inserting one finger or several fingers, and thus any part may be used (or come in contact) from any direction, the perforated section formed at the center also preferably has a circular shape, but is not necessarily limited thereto.

The circular shape is preferable due to its gradual slope in all directions, allowing natural movements of fingers along the slope, as well as its stability.

In addition, the concavely curved shape of the body contact sections 53 (finger insertion sections) provides a good wearing sensation due to a small contact area with the backs of fingers inserted into the belt during use, has small resistance when a direction of the device is changed as necessary during use, and prevents curling (twisting) of the center of the belt due to repeated use.

Effects of the present invention formed as described above will be explained with reference to use state views of FIGS. 4 to FIG. 10.

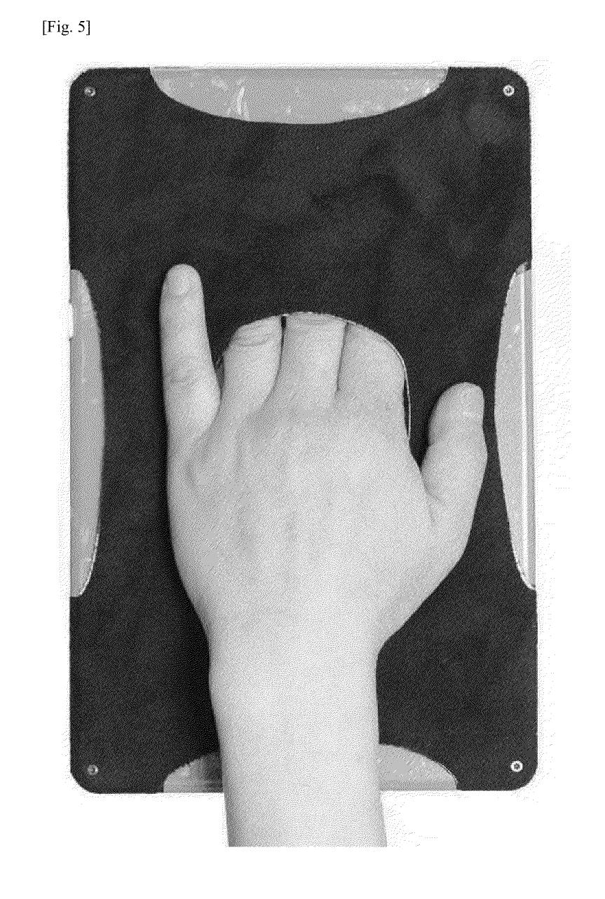

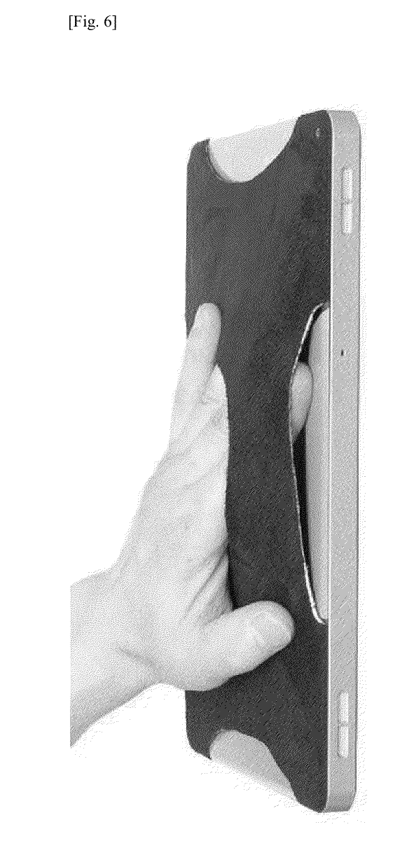

FIG. 4 shows a longitudinal use, which is an easy posture for turning in a transverse direction. Furthermore, FIG. 5 is a palette-type grip for drawing pictures, which is conducive to turning in both transverse and longitudinal directions. FIG. 6 is a view of FIG. 5 from another angle.

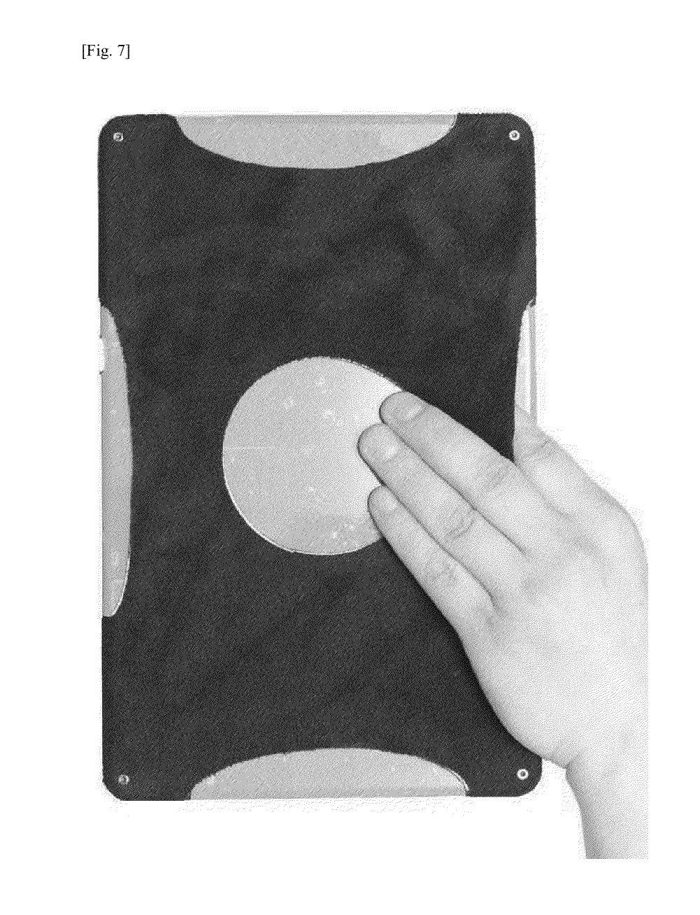

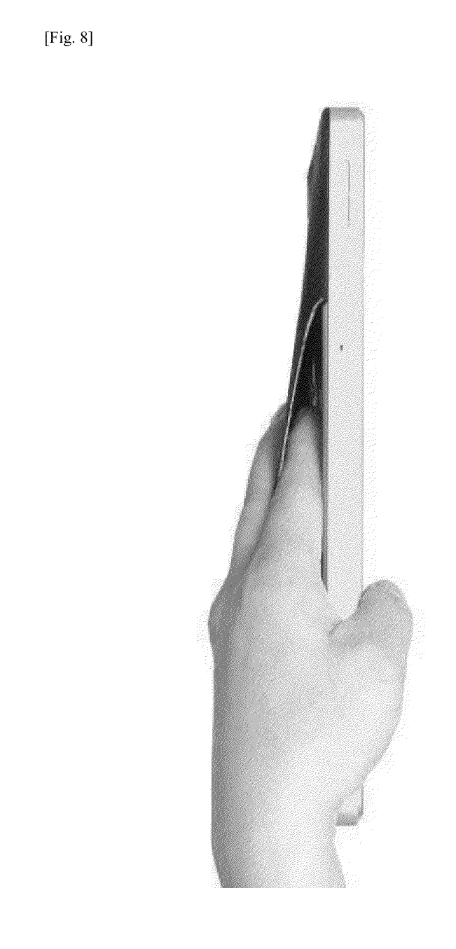

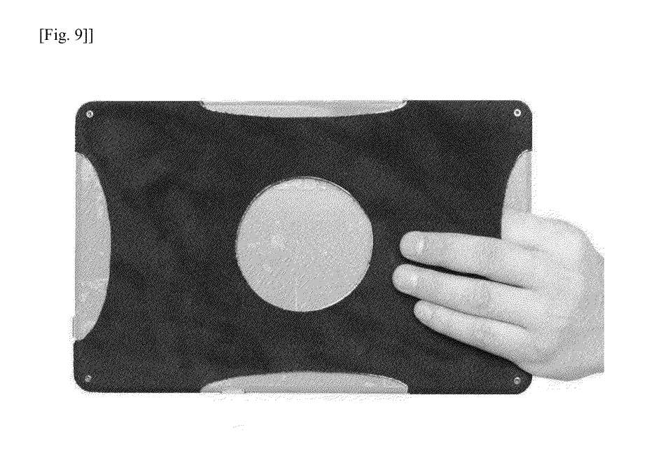

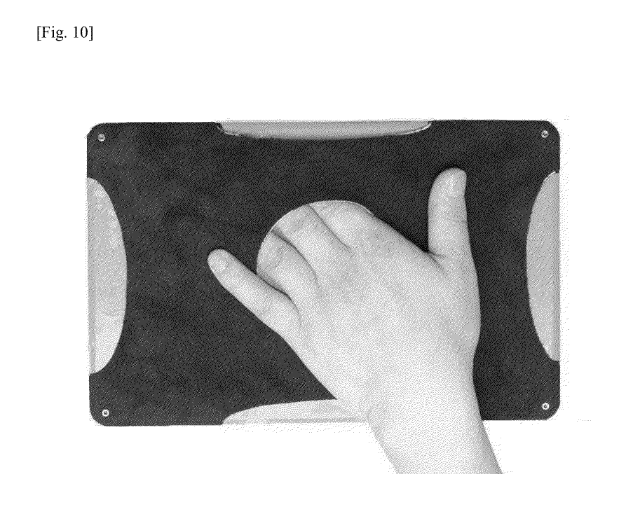

FIG. 7 is a method of a longitudinal side grip, and FIG. 8 is a side view of FIG. 7. FIG. 9 is a method of a transverse grip of a tablet PC. Such methods need not be learned, but allow users to grip naturally and intuitively. In addition, FIG. 10 is a method in a transverse direction allowing users who have weak fingers and wrists to grip the device.

As described above, the present invention allows a device to be freely gripped and turned in any direction with any posture, and as such is a very useful accessory for so-called tablet PCs, e-Book readers and the like, which have been in the spotlight recently.

The embodiments explained above in the modes of the invention are based on concepts that clearly demonstrate the ideas of the present invention. Accordingly, the scope of protection of the present invention is not limited to the embodiments described above and should be decided according to the following claims.

1. A grip structure of a portable terminal which has a plate-shaped grip structure formed on a rear surface of the portable terminal, the grip structure comprising:
fixed sections fixed in shapes surrounding four corners of the rear surface;
a perforated section formed at a center to allow insertion of fingers; and
body insertion sections formed at four sides connecting the fixed sections in a vertically symmetrical structure to allow insertion of fingers,
wherein the body insertion sections are concavely curved toward the perforated section.

2. The grip structure of claim 1, wherein the perforated section is formed in a circular shape.

3. The grip structure of claim 1, wherein the grip is made of leather or a fabric.
